(19) United States
(12) Patent Application Publication
(10) Pub. No.: US 2016/0379038 A1
(43) Pub. Date: Dec. 29, 2016

(54) VALID FINGER AREA AND QUALITY ESTIMATION FOR FINGERPRINT IMAGING

(71) Applicant: QUALCOMM Incorporated, San Diego, CA (US)

(72) Inventors: Esra VURAL, Santa Clara, CA (US); Eliza Yingzi DU, Cupertino, CA (US)

(21) Appl. No.: 15/190,802

(22) Filed: Jun. 23, 2016

Related U.S. Application Data
(60) Provisional application No. 62/186,315, filed on Jun. 29, 2015.

(51) Int. Cl. G06K 9/00

(52) U.S. Cl. CPC G06K 9/0008; G06K 9/00013; G06K 9/001

(57) ABSTRACT

Techniques for fingerprint quality assessment are presented. In some embodiments, a fingerprint image is subdivided into a plurality of sub-images. An orientation and a frequency associated with fingerprint ridges or valleys can be determined for each sub-image. A model can be generated for each sub-image and then compared to each sub-image. Based on the comparing, a quality assessment can be determined for each of the sub-images.

### CROSS-REFERENCE TO RELATED APPLICATIONS

This application claims priority to U.S. Provisional Application No. 62/186,315, filed Jun. 29, 2015, the disclosure of which is incorporated by reference herein in its entirety.

### BACKGROUND

Aspects of the disclosure relate to fingerprint quality assessment methods for mobile devices.

Mobile devices can be multi-functional devices (e.g., smartphones) that are used for a wide variety of purposes including social interaction, financial transactions, personal healthcare management, work related communications, business dealings, etc. As such, these devices can access, store, and/or display confidential and/or sensitive information. Fingerprint recognition on mobile devices can provide an enhanced level of security for a user (e.g., owner) of the mobile device, as it is difficult to duplicate or imitate the user's unique fingerprint biometric signature. Additionally, fingerprint readers can offer a level of convenience by enabling quick and secure access to the mobile device or sensitive information at the mobile device.

Various techniques can be used to enroll an imaged fingerprint of a user or match an image of a fingerprint with a fingerprint template (to allow or deny access). Edge detection and strength of edge gradient techniques are techniques that can be used to determine valid fingerprint area within a fingerprint image for further processing (e.g., matching or enrollment). These techniques may perform poorly with images that are relatively noisy and/or have a low contrast due to several factors. Some of these factors are associated with increasingly diminutive sizes of fingerprint sensors, as well as the use of various materials and thickness of platen material between a fingerprint sensor and a fingerprint of a user. These factors can lead to relatively high fingerprint image false rejection and/or false acceptance rates which, in turn, can lead to security breaches or wasted resources in reprocessing or recapturing fingerprint images.

Accordingly, a need exists for improvement in the field of fingerprint pattern quality assessment.

### BRIEF SUMMARY

Certain embodiments are described that provide techniques for fingerprint quality assessment and valid fingerprint area recognition on a mobile device.

Techniques are disclosed that can include obtaining an image of a fingerprint and subdividing the image into a plurality of sub-images. An orientation of ridges or valleys of the fingerprint within sub-images of the plurality of sub-images can be determined. A frequency associated with spacing of the ridges or valleys of the fingerprint within the sub-images of the plurality of sub-images can be determined. One or more models can be generated, each based on the orientation and the frequency of each sub-image of the sub-images. Each of the one or more models can be compared with a corresponding sub-image of the sub-images. Based on the comparing, a quality assessment of the image of the fingerprint can be determined. A function of a device can be modified based on the determining the quality assessment.

### BRIEF DESCRIPTION OF THE DRAWINGS

Aspects of the disclosure are illustrated by way of example. In the accompanying figures, like reference numbers indicate similar elements.

FIG. 1A illustrates a flowchart including techniques for acquiring and processing fingerprint images by a device, according to certain embodiments.

FIG. 1B illustrates a flowchart including techniques for determining valid fingerprint area within a fingerprint image, according to certain embodiments.

FIG. 1C illustrates a flowchart including techniques for performing fingerprint image quality assessment, according to certain embodiments.

FIG. 2A illustrates segmenting example fingerprint images according to certain embodiments.

FIG. 2B illustrates several example fingerprint image and fingerprint image models according to certain embodiments.

FIG. 3 illustrates several example fingerprint images includes several features that can be determined using techniques of certain embodiments.

FIG. 4 illustrates an example chart of false acceptance and rejection rates using techniques of certain embodiments.

FIG. 5 illustrates an example embodiment of a device that can use techniques of certain embodiments.

FIG. 6 illustrates a fingerprint imaging sensor that can be used to obtain fingerprint images that can be processed using techniques of certain embodiments.

FIG. 7 illustrates example fingerprint images and results of quality assessments using techniques of certain embodiments.

FIG. 8 illustrates a flowchart including techniques for processing fingerprint images, according to certain embodiments.

FIG. 9 illustrates a flowchart including techniques for processing fingerprint images, according to certain embodiments.

FIG. 10 illustrates an example of a computing system according to certain techniques.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

The techniques for fingerprint quality assessment and valid fingerprint area determination described herein can enable robust, accurate, and expeditious assessment of fingerprint images under a variety of conditions. Certain embodiments can be implemented through use of a mobile electronics device, such as a cell phone, laptop computer, or other. The techniques described herein can be used to implement fingerprint recognition and quality assessment techniques for distorted or other fingerprint images. Fingerprint images can be distorted due to design limitations, environmental constraints, biological limitations of a specific user's fingerprint, dirty imaging area(s), and/or for other reasons.

The techniques can pertain to subdividing an image of a fingerprint into sub-images. The sub-images can then be analyzed to obtain, for example, dominant orientations and/or characteristic frequencies of fingerprint ridges or valleys within each of the sub-images. A model of each of the sub-images can be generated using the dominant orientation and characteristic frequency of each sub-image. Each model can be compared to a corresponding sub-image to assess if each sub-image is suitable for use in fingerprint enrollment and/or matching. In certain embodiments, the one or more models can be analyzed to determine, for example, if the one or more models are generated from valid fingerprint information.

Various analyses can be used to ascertain the quality of the fingerprint image. These analyses can use information gleamed from the comparisons of each model with a corresponding sub-image of a fingerprint. This information can be used to assess an overall quality of a fingerprint image and/or assess an area of the fingerprint image containing valid fingerprint data suitable for further processing (such as fingerprint enrollment or matching). These assessments can be used with a plurality of fingerprint images to determine whether the plurality of images can be used as a set to create a fingerprint template for a user. The fingerprint template can be stored and used for matching of subsequent image(s) of a fingerprint to determine if a fingerprint image corresponds to a matched template. If so, a user can be authorized or validated for using a device.

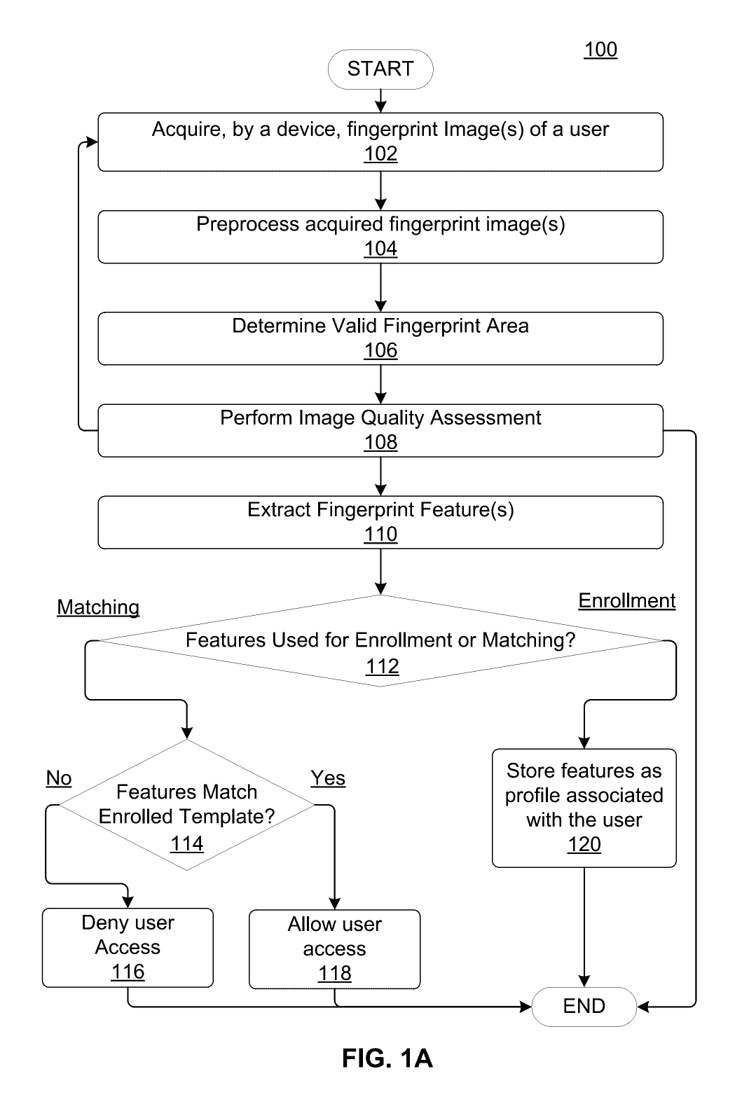

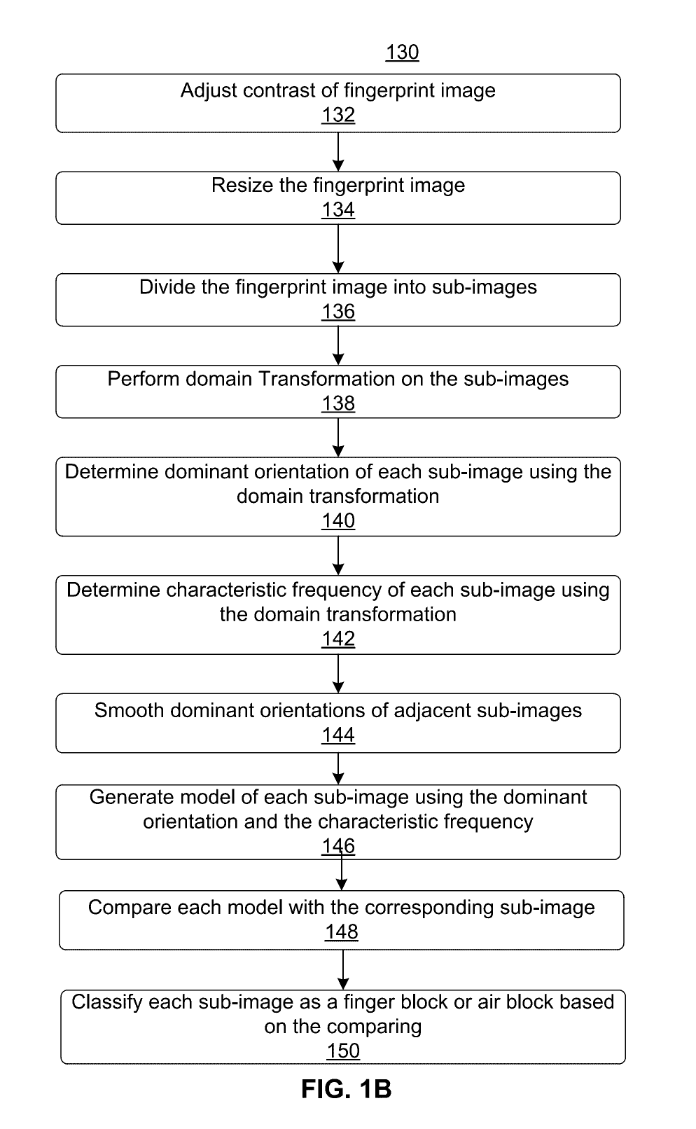

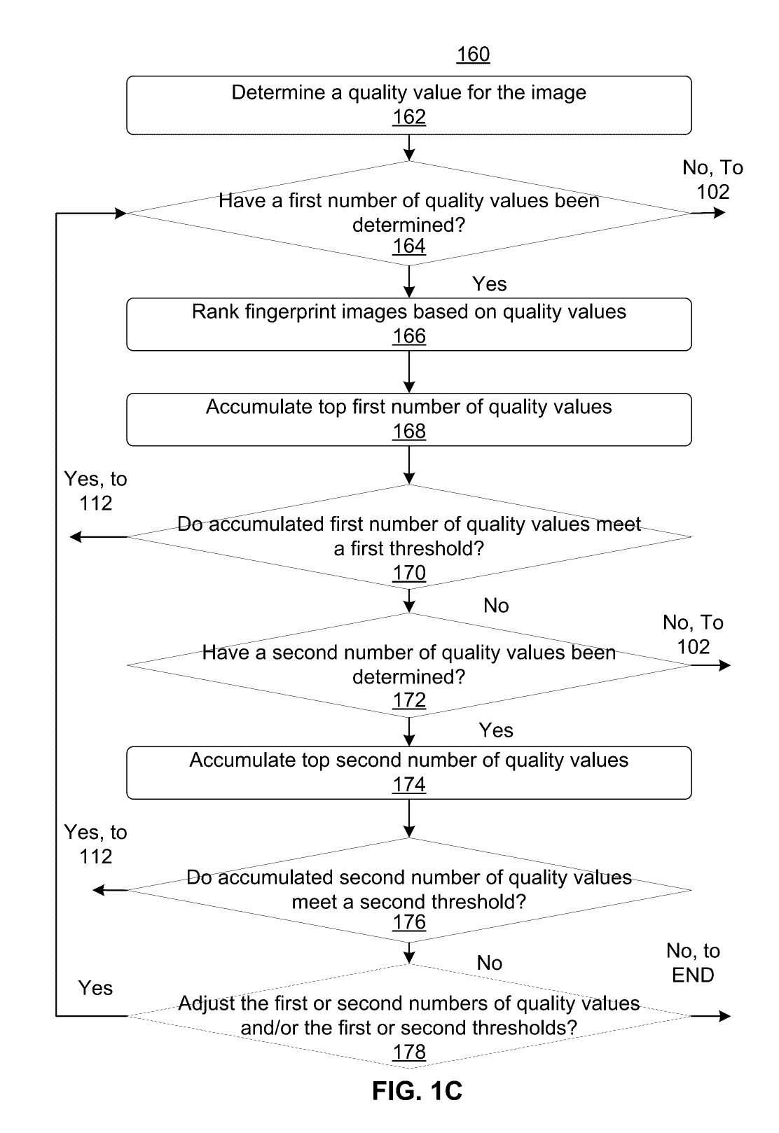

FIG. 1A illustrates a flowchart including techniques for acquiring and processing fingerprint images by a device, according to certain embodiments. At 102, fingerprint image(s) of a user can be acquired by a device. The fingerprint image(s) can be acquired for a single digit of a user or of several digits. Various sensors can be used for imaging of fingerprint(s). As one example, an ultrasound sensor can be used for imagining. Additional examples include an imaging sensor, a touch sensor (such as a capacitive sensor), a thermal sensor, or other. The sensor of a mobile device can be physically constrained such that only a portion of a fingerprint is acquired at a time.

At 104, the fingerprint image(s) can be preprocessed. Preprocessing can include various techniques to ready an image for further processing (including quality assessment and feature extraction). For example, preprocessing can include stitching two or more fingerprint images together to form a larger fingerprint image. Mobile devices, such as smartphones can have a relatively miniscule fingerprint imaging sensor that is incapable of capturing an entire image of a fingerprint. Therefore, the imaging sensor may only capture a portion of a complete fingerprint. Although this partial picture may be adequate for matching a fingerprint to a fingerprint template, it may not be adequate for creating a template via enrollment. For enrollment, a larger/more complete image of a fingerprint may be desired to account for variation in the position of a captured image of a fingerprint by a fingerprint sensor. During an enrollment process, a user may be directed to position one or more digits to be imaged by a fingerprint sensor multiple times. Each of these images can later be stitched together into a more complete image. Certain devices may also use stitching for matching techniques. For example, a swiping or other motion can be used by a user when attempting to log onto a device or perform a protected function. During a swiping motion, several different fingerprint images can be acquired.

Stitching images of a fingerprint together can entail locating various features of each image in order to maintain the integrity of the overall fingerprint image. For example, ridges and/or valley in a fingerprint can be continued across the images captured by a fingerprint sensor to obtain a larger image that maintains ridge and valley features useful for enrollment and/or matching. Depending on the shape and other characteristics of a fingerprint sensor acquiring each image, a stitched image of the fingerprint can be irregular and/or polygonal. For example, a fingerprint sensor can be rectangular. Fingerprint images can be acquired at various angles and/or at various locations for a given finger. Stitching these individual images together while maintaining valid valley/ridge information can result in a polygonal larger image that may not be rectangular.

Preprocessing can also include adjusting a gray scale of a fingerprint image or otherwise adjusting a contrast of the image. When acquiring grayscale images of fingerprints, such as by an ultrasonic sensor, a certain range of gray scale values may be present in the image due to limitations of the sensor, compression of image data, etc. Adjusting the gray scale value can extend a possible range of values of the color gray present in the image, providing more separation between gray color values and increasing contrast. This operation can facilitate further processing of the image by simplifying, expediting, and/or increasing the accuracy of detection of fingerprint characteristics that are reproduced in gray scale, such as ridges or valleys of the fingerprint.

Preprocessing can also include padding of the image. Padding can introduce additional pixels that can be added above, below, or to either side of an image in order to “frame” the image. This method can be applied symmetrically and can alter the image dimensions to enable even subdivision of the image into sub-images. The padding can use uniform magnitudes of pixel intensities in order to avoid introducing artifacts that may later be identified or result in skewed fingerprint identification.

Preprocessing can also include changing a size and/or resolution of an image. For example, an image can be stretched, compressed, shrunk, skewed, or otherwise altered to obtain an image of set size and/or resolution. Modifying the size and/or resolution of a fingerprint image can result in an image that is more easily divisible. The modification can also reduce computational overhead when performing operations, as disclosed herein, on the fingerprint image(s).

Preprocessing can also perform initial edge detection to estimate a fingerprint area present within a fingerprint image. The estimation of fingerprint area can include edge detection, convex hull, or other techniques. This estimation can aid in bounding an area of the fingerprint image for further processing and, in turn, decrease processing time associated with performing quality assessment, matching, and/or enrollment using a fingerprint image. The estimation of the fingerprint area can be performed relatively quickly to obtain a rough estimate of valid fingerprint area without performing more extensive/processing intensive operations.

### Determining Valid Fingerprint Area

At 106, valid fingerprint area can be determined. Determining valid fingerprint area can aid in performing quality assessment of an image. The determination of valid fingerprint area can also be used to assess and flag portions of an image having invalid fingerprint area so that further processing need not be performed on the invalid areas. Valid Fingerprint Determination can include the steps of flowchart 130 illustrated in FIG. 1B. As a result of determining valid fingerprint area, a mask can be applied to a fingerprint image. The mask can be generated using edge detection, convex hull, or other techniques. The mask, when applied to an image of a fingerprint, can be used to extract areas of the fingerprint that have been identified to contain valid fingerprint information.

At 132, a contrast of a fingerprint image can be adjusted. The contrast can be adjusted in order to accentuate certain features of a fingerprint image. For example, biometric features of a fingerprint image can be extracted from ridges, valleys, keypoints or other features of a fingerprint that form a unique biometric signature. The ridges and valleys can appear as alternating bright and dark areas within a fingerprint image. By adjusting the contrast of an image, the ridges and valleys may become more apparent, aiding in recognition and definition of the ridge/valley structures of a fingerprint image. As one example of adjusting contrast of an image, a color or intensity delta between ridges and valleys can be increased. Otherwise, contrast can be adjusted to provide more details to ridges and/or valleys in order to aid in recognition of unique biometric features of each (e.g., contrast can be adjusted to provide more separation between intensity or color of pixels between ridges and valleys).

At 134, the fingerprint image can be resized. For example, an image can be stretched, compressed, shrunk, skewed, or otherwise altered to obtain an image of set size and/or resolution. Modifying the size and/or resolution of a fingerprint image can result in an image that is more easily divisible into sub-images. For example, each sub-image can be a certain resolution and/or size. The image can be resized to a multiple of the resolution and/or size of each sub-image. The resizing can reduce computational overhead when performing division of the image into sub-images or other techniques on the fingerprint image(s).

### Dividing Image Into Sub-Images

At 136, the image can be divided into sub-images. As used herein, the term sub-image encompasses various shapes of sub-images including square, rectangular, polygonal, or organic shapes. The subdivision of the image can use adaptive algorithms to alter the shape, amount, and/or size of the sub-images used for subdivision. Each sub-image can comprise a non-overlapping or overlapping portion of the image. The sub-images can enable distinct portions of the image to be analyzed both individually and interrelatedly, as will be disclosed herein. A number of sub-images can be determined based on rules, via an adaptive technique, or via various other techniques. For example, a fingerprint image of a set size or resolution can be obtained. A number of sub-images can be predetermined, such as a matrix of 24×24 sub-images. The sub-image size or resolution can then be adapted such that the size of the image is a whole integer (or close to a whole integer) multiple of the sub-image in order to reduce computational complexities associated with subdividing an image. Various other techniques can be used. For example, the sub-images do not have to be equal in size or resolution. An adaptive algorithm can be used to select sub-image sizes, resolution, and/or locations within a fingerprint image.

The sub-images can be selected such that a portion of the fingerprint image captured by each sub-image contains a dominant orientation and characteristic frequency, as is disclosed herein. For example, a size of a sub-image can be selected such that fingerprint ridges and/or valleys within a sub-image are relatively evenly spaced and are oriented similarly. The size, shape, location, and/or orientation of the sub-images can therefore be selected to optimize the frequency and orientation of fingerprint ridges and/or valley captured within each sub-image. The optimization can include minimizing the number of dominant orientations and/or characteristics frequencies of ridges or valleys within each sub-image.

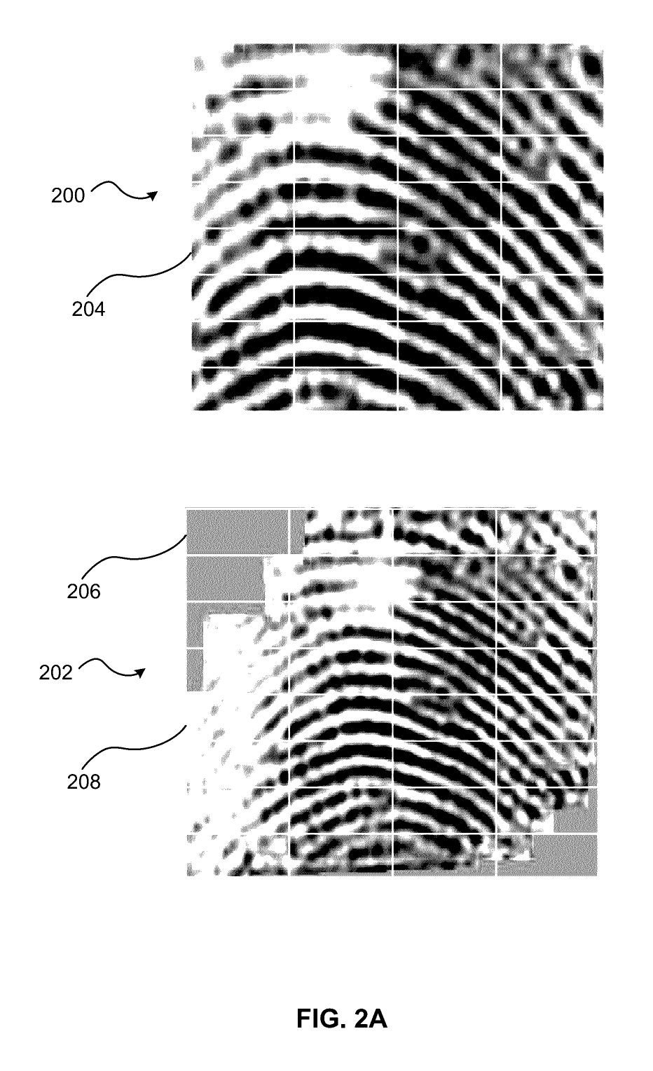

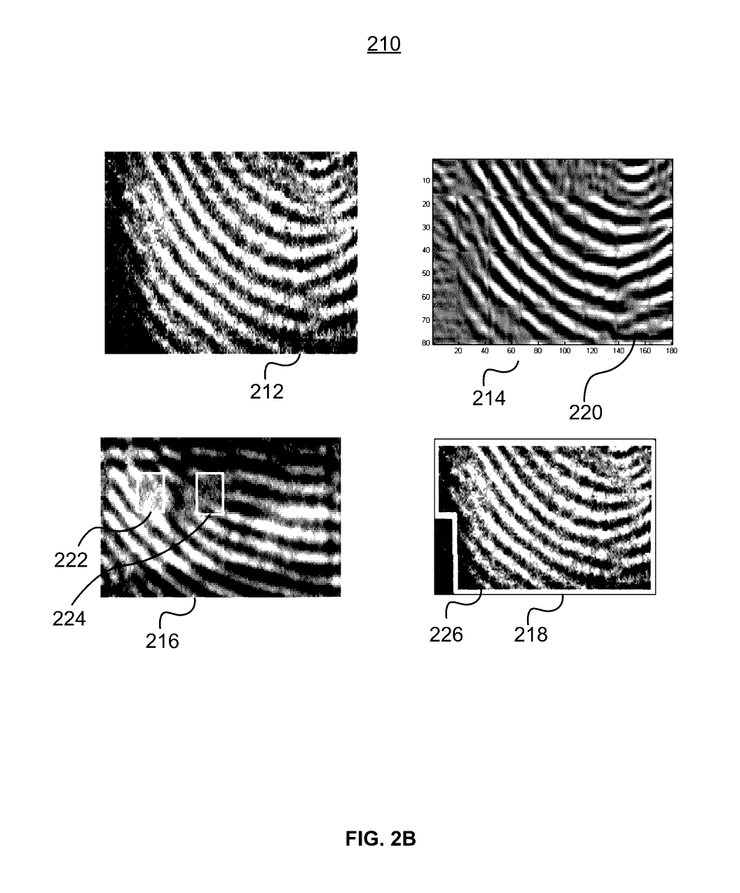

FIG. 2A illustrates division of two different sub-images 200 and 202 into sub-images, exemplified by 204 and 208, respectively. Fingerprint image 200 illustrates a complete fingerprint image containing no air sub-images (sub-images without valid fingerprint information). Thus, every sub-image 204 of image 200 contains valid fingerprint information as ridges and valleys. Fingerprint image 202, in contrast, contains both valid sub-images 208 and air sub images 206. Air sub-images 206 do not contain valid fingerprint information in the form of ridges or valleys, as illustrated. Fingerprint image 208 (or 200) can be an image stitched together from a plurality of fingerprint images, for example.

### Performing Domain Transformation on Sub-Images

At 138 of FIG. 1B, a domain transformation can be performed on each of the sub-images. The domain transformation can be, for example, between a spatial domain and a frequency domain. One method of performing a domain transformation is through use of Fourier transform techniques. The domain transformation can include applying a Hamming window to each sub-image. The Hamming window can be applied via a Hamming technique that can be applied to each sub-image so that image data is approximately zero value outside of a chosen interval (e.g., the bounds of each sub-image). The use of a window technique can aid spectral analysis of the image by reducing or eliminating high frequency noise that can result from discontinuous spectral transformations of adjacent sub-images. This type of high frequency noise artifact can be common when a Fourier transform, for example, is applied to the sub-images. This is because the Fourier transform can produce a frequency domain image of the spatial image wherein the frequency domain image is a summation of infinite cosine components that can extend beyond the bounds of a sub-image. As these cosine-like representations are infinite and continuous, there can exist high frequency edge artifacts between adjacent sub-images when cosine components are used with non-aligned phases. Therefore the value of the cosine components at the edges between sub-images may be discontinuous because of the lack of phase alignment. Hamming window techniques can minimize these edge variations. Other transformation techniques, including other window techniques, can be used to similar effect.

The domain transformation of 138 can be performed through use of a two dimensional Fourier transformation on each sub-image of a fingerprint image. The Fourier transformation can provide a spectral/frequency representation of each spatial sub-image and can enable additional image analysis and processing. While a Fourier transform is mentioned here as an example technique for performing a domain transformation, other techniques for domain transformation may be used that convert the image data into a domain that more easily reveals relevant characteristics for use in biometric identification. Returning to the example of the Fourier transform, the resulting frequency domain images may represent two dimensional representations of cosine components of the images. The magnitude of a pixel of the frequency domain image can represent the magnitude of the particular cosine component. The axes of the spectral image can represent frequencies of the cosine components. The location of a pixel on the frequency domain image can indicate the combination of frequencies of cosine components of two axes.

Fourier transformations can, for example, be accomplished using Fast Fourier Transformation (FFT) techniques through use of a processor or controller. The processor can be a System on a Chip (SoC) Such as a Qualcomm® Snapdragon™ brand SoC. Alternatively, a domain transformation can be performed using dedicated and/or fixed-function hardware that can be integrated with a mobile device including a fingerprint imaging sensor.

Each sub-image can optionally be band-pass filtered to remove high frequency and/or low frequency noise. An example band-pass filter is a Butterworth filter that can have a relatively flat frequency response over frequencies of interest (to be passed). A band-pass filter can be chosen to pass frequencies useful for determining finite changes in gray scale colors, and can aid in edge detection and orientation/frequency detection of fingerprint ridges. A low-pass filter can alternatively be used to filter out high frequency noise. This filtering can be accomplished in a spatial, frequency, or other domain of a sub-image (or an image containing sub-images).

### Dominant Orientation Determination

At 140, a dominant orientation of ridges and/or valleys in each sub-image can be determined using the domain transformation of each sub-image determined in 138. As an example, a fingerprint ridge or valley in a spectral image sub-image can be represented by a line of pixels with like colors, the colors indicating a peak grayscale color (either relatively bright/white or relatively dark/black, for example).

Fingerprints generally consist of alternating ridges and valleys in a unique and non-uniform pattern. Dividing a fingerprint image into sub-images, as per 136, can result in sub-image that contain relatively uniform and aligned ridges and valleys that can appear to form uniform “waves.” Frequency representations of these valleys and ridges can be indicated by relatively high magnitude pixels (or groups of pixels) within the frequency domain image. The relative locations of these high magnitude pixels (or groups of pixels) can be used to ascertain an orientation of ridges or valleys within a sub-image by, for example, locating frequency components on two different axes corresponding to the pixels. The magnitude of each axis component can be used to calculate the orientation of a frequency component. Depending on the location and size of each sub-image, a singular dominant frequency indicating spacing between ridges and valleys of a fingerprint can be determined for each sub-image.

In certain embodiments, sub-images can be determined that lack a singular dominant orientation or any orientation. These sub-images can lack fingerprint information in the form of valleys/ridges due to, for example, dirt on an imaging device, a scar on a digit of a user, limitations in sensing technology, or other reasons. These sub-images are herein referred to as “air sub-images.” Air sub-images can be flagged so that future processing steps can ignore these sub-images, for example, as they may not contain determinable fingerprint information for enrollment or matching. As another alternative, two or more orientations can be determined within a single sub-image. In such an instance, the two or more orientations may be averaged. In certain embodiments, weighted averaging or other techniques can be used within a sub-image to determine a dominant frequency therein. In certain embodiments, each orientation can be weighted by a magnitude of pixel(s) within each valley or ridge corresponding to the orientation.

Several techniques can be used for determination of air sub-images. One technique can include detection of an absence of a peak (e.g., over a certain absolute threshold or a certain delta threshold when compared to neighboring pixels) in a frequency domain image of a sub-image. The absence of a peak can connote that there are no uniform ridges/valleys in the image sub-image. Another method of determining an air sub-image includes comparing a ratio of a largest peak magnitude to an average of magnitudes pixels within a frequency domain representation of a sub-image. If this ratio is less than a threshold value, the sub-image can be flagged as an air sub-images. In certain embodiments, a further phase or other transformation of a spatial image can be generated to aid in determination of dominant orientation, or other information.

### Characteristic Frequency Determination

At 142, a characteristic frequency of ridges and/or valleys within each sub-image can be determined. A characteristic frequency of ridges and valleys can be determined via location of absolute high magnitude or relatively high magnitude pixels within a frequency domain representation of each sub-image. The location of these pixels can be used to determine frequencies of components of each ridge or valley, similar to the method discussed above for step 140. In certain embodiments, a sub-image can contain relatively uniformly spaced ridges and/or valleys. As such, a singular characteristic frequency may be determined from peaks of the ridges and/or valleys. In certain embodiments, the weighted average of the magnitude of a group of pixels representing a peak of the frequency domain image of each sub-image of the fingerprint can be used to weigh frequency components obtained from the pixels.

### Smoothing Adjacent Sub-Images

At 144, characteristics of sub-images adjacent to a specific sub-image (optionally excluding air sub-images) can be used to improve characteristics of each sub-image. This process is known as smoothing and can consist of modifying the dominant orientation of each sub-image by comparing the dominant orientation of each sub-image with the dominant orientations of adjacent sub-images. In this manner variations between dominant orientations of adjacent sub-images can be reduced. Smoothing can take advantage of a characteristic of most fingerprints wherein the ridges/valleys can generally form generally uniform flowing patterns. These patterns can extend across multiple sub-images of the image. The smoothing can improve the accuracy of an idealized model described herein by better aligning orientations between sub-images giving a more accurate model of the fingerprint. The smoothing can use an averaging, recursive, or other function to minimize variations between orientations of sub-images across the entire fingerprint image.

Furthermore, smoothing can account for orientation artifacts introduced by dividing the fingerprint image into sub-images 136. As disclosed herein, a dominant orientation can be determined for each sub-image. However, fingerprint valley and/or ridges can form a wave pattern around, for example, a center of a finger. By smoothing adjacent sub-images, a model of the fingerprint image using the sub-images can be improved.

### Generate Model of Each Sub-Image

At 146, a model can be generated for each sub-image using the dominant orientation and characteristic frequency of each sub-image. For example, a Gabor wavelet model can be generated using this information. Using the dominant orientation and/or characteristic frequency of each sub-image, the model generated can appear to be an idealized model of the underlying fingerprint information contained within each sub-image. For example, the wavelet model can be generated using the orientation and frequency information of each sub-image obtained, for example, at 140 and 142. The model can further be improved using additional characteristics of a sub-image. For example, additional frequency or orientation characteristics can be determined for each sub-image to, for example, locate local maxima and minima. Additional characteristics can be used to obtain a more accurate model of a sub-image at the expense of additional processing overhead.

Comparing Each Model with a Corresponding Sub-Image

At 148, models of each sub-image are compared and/or filtered with a corresponding sub-image. This comparison can be performed in a frequency, spatial, or other domain. The comparison can include convolving each model with each sub-image in the spatial domain.

The convolution of the images can result in an image that can be used to assess a degree of similarity between each model and each corresponding sub-image. The convolution of two identical images results in an images with a peak having a relatively high magnitude that can be represented by a relatively tight grouping of high magnitude pixels in a resulting image. Conversely, dissimilar images can result in a convoluted image that has lower magnitude pixels that are more highly dispersed. Thus, by examining the results of the convolution, a determination can be made regarding a degree of similarity between each model and corresponding sub-image. It should be understood that other techniques may be used to assess the difference between the idealized model and the fingerprint images. As another example, Gabor, or other filtering can be used to obtain a Gabor output for each image. Gabor, or other filtering, can be performed on a two dimensional sub-image in a spatial or frequency domain. In certain embodiments, Gabor filtering can be used to generate a Gabor enhanced image. In certain embodiments, the Gabor enhanced image can be used to assess whether each sub-image that the Gabor enhanced image corresponds to contains valid fingerprint information. In certain embodiments, Gabor enhanced images can be compared to a corresponding sub-image to obtain an image used to assess whether each sub-image contains valid fingerprint information.

Gabor filtering can be accomplished by convolving sub-images with a two dimensional Gaussian kernel with σ=1 and subtracting the convolution from the input image to obtain a sharpened image I, wherein σ is a standard deviation. A Gabor response can be determined for each sub-image for each orientation of the kernel. Next, a convolution of the magnitude of each Gabor response with a two dimensional Gaussian kernel with σ=4 can be performed. An average Gabor response can be determined at each location of a fingerprint image yielding a map of averages. A standard deviation can be determination for the map of averages.

The Gabor filtering can be accomplished through the use of

$$equation h ( x , y , f , θ , {σ}_{x} , {σ}_{y} ) = exp ( \frac{- 1}{2} ( \frac{{x}_{θ}^{2}}{{σ}_{x}^{2}} + \frac{{y}_{θ}^{2}}{{σ}_{y}^{2}} ) exp ( j2π {fx}_{θ} ) ) ,$$

where

x_{θ}=x sin θ+y cos θ; y_{θ}=x cos θ−y sin θ;

f:

$$frequency \frac{cycles}{pixel} of the sinusoidal plane wave ;$$

### θ: Orientation;

σₓσ_{y}: Size of Gaussian smoothing window ; Filter bank size=1; and θ=0,

$$\frac{1}{4 π} , \frac{2}{4} π , \frac{3}{4} π ,$$

for example.

### Classifying Each Sub-Image as a Finger Sub-Image or Air Sub-Image

At 150, each sub-image can be classified/flagged as either being a finger sub-image or an air sub-image. A finger sub-image indicates that valid fingerprint information is contained therein for enrollment or matching purposes. An air sub-image indicates that the sub-image indicates that no valid fingerprint information is contained therein for enrollment or matching purposes. By classifying each sub-image, a finger coverage area can be determined for a fingerprint image.

Various features of each sub-image can additionally be used for this determination including, but not limited to, a characteristic frequency of each sub-image, a Signal to Noise Ratio (SNR) for each block, an Orientation Certainty Level (OCL), a global orientation, a sharpness, entropy, and/or a contrast ratio between ridges and valleys. In certain embodiments, sub-images can be classified as a finger sub-image if their characteristic frequency is within a certain range and/or within a similar tolerance to adjacent sub-images or average values across a fingerprint image. The SNR of a sub-image can be determined to determine if the sub-image is too noisy for further processing and would not yield valid fingerprint information. An entropy value can be determined for each sub-image and/or each filtered sub-image. For example, an entropy value can be determined for a Gabor enhanced image or a Gabor enhanced image compared to a corresponding sub-image. An entropy value can be a quantitative value indicating a level of randomness within an image. An entropy value indicating that pixels, shapes, and/or other features of an image or relatively uniform can indicate that valid fingerprint ridge/valley information is contained therein.

An OCL of each sub-image can be determined from the dominant orientation of each sub-image. For example, a Sobel kernel can be applied to sub-images to compute an intensity gradient for each sub-image. A gradient covariance matrix can then be determined. An OCL can be measured from eigen values of the gradient covariance matrix. For example, covariance matrix can be determined by the equation

$$C = \frac{1}{N} {Σ}_{N} [ \frac{d x}{d y} ] [ dx dy ] ,$$

wherein N are the number of sub-images, and x and y represent horizontal and vertical coordinates of changes in intensity of each sub-image. Minimum and maximum Eigenvalues of C can be determined as λ min and λ max respectively. The OCL can be determined as

$$OCL = \frac{λ min}{λ max} .$$

The OCL can be of value between 0 and 1, with lower scores indicating more energy along ridges and/or valleys of a fingerprint image.

A global orientation can include a map of orientations determined for sub-images. As ridges and valleys of a fingerprint generally form circular or arcing patterns, orientations of sub-images can be assessed as a whole to determine if the orientation form circular or arcing orientations across adjacent sub-images. A global orientation coherency map can indicate, for example, if a sub-image contains invalid orientation or other information and should be rejected as an air sub-image.

Sharpness can be a combination of resolution and acutance. Sharpness can indicate a steep transition between magnitudes of pixels (e.g., magnitudes of brightness, color, etc.). Sharpness can be used to determine how well ridges or valleys within an image can be detected. Similarly a contrast between ridges and/or valleys can be determined and used as a feature for classifying a finger or air sub-image. Sharpness can be estimated by measuring spatial image resolution and contrast, vertically and horizontally. For example, for each of the horizontal and vertical alignments, a peak frequency and period can be determined. A first peak can then be found as well as valley(s) and additional peaks. Next a vertical and horizontal sharpness can be determined. An overall sharpness value can be selected from the horizontal and vertical sharpness values having the least variation. Alternatively sharpness can be determined as λmax, as disclosed above.

FIG. 2B illustrates example fingerprint images 212, 214, 216, and 218. Fingerprint image 212 is a raw, spatial domain fingerprint image. Fingerprint image 214 is a sub-divided and modeled spatial domain image of fingerprint image 212. Each of sub-images 220 has been determined using a wavelet model generated using a dominant orientation and characteristics frequency of a corresponding sub-image of image 212.

Fingerprint image 216 shows two sub-images, 222 and 224 that are determined to be air sub-images. Air sub-images 222 and 224 are illustrated as lacking readily determinable fingerprint ridge or valley information. In fingerprint image 218, a valid fingerprint area 226 has been determined by classifying each sub-image within fingerprint image 218 as a finger sub-image or air sub-image. Thus, sub-images outside of fingerprint area 226 has been determined to be an air sub-image.

### Determine a Quality Value for the Image

FIG. 1C illustrates flowchart 160 for performing image quality assessment 108 of FIG. 1A. At 162, a quality value can be determined for the image. Several different features can be used to determine the quality value. For example, an amount of finger coverage (determined by flagging sub-images as finger sub-images or air sub-images), a mean entropy value for the image, a mean SNR for the image, a ridge length, and/or a number of air sub-images within an image. These and other values can be measured and/or weighted in various ways to obtain a quantitative image quality value. For example, a quality value can be continuous from 0.0 to 10.0. The use of the quality value can be used to compare fingerprint images and as a criteria for selection of fingerprint images for enrollment or matching.

Steps 164-178 can, for example, encompass a process useful during enrollment of fingerprint image(s) to determine if a certain number of fingerprint images are useful for generation of a fingerprint profile. At 164, a determination can be made as to whether a first number of quality values have been determined, each for a corresponding fingerprint image. If they have not, the method can proceed to 102. If they have, the method can proceed to 166. At 166, the fingerprint images/quality values can be ranked, such as from highest quality value to lowest quality value. At 168, the top first number of quality values can be accumulated.

At 170, a determination can be made if the accumulated quality values meet a first threshold. If the accumulated quality values do meet the threshold, indicating that a minimum number of relatively high value fingerprint images have been obtained, the method can proceed to 112. If the accumulated quality values do not meet the threshold, a determination can be made if a second number of quality values have been determined. If not, the method can proceed to 102. If they have, the second number or top ranked quality values can be accumulated.

At 176, a determination can be made if the second accumulated quality values meet a second threshold. If the second accumulated quality values meet the second threshold, indicating that a higher number of moderately high quality images have been obtained, the method can proceed to 112. If not, the method can proceed to optional step 178. At 178, the various numbers of accumulated quality values and thresholds for determining if significant numbers of high or moderate quality images have been obtained can be adjusted. By adjusting these values, the quality assessment criteria for selecting fingerprint images can be adjusted during enrollment process, for example.

The technique of 164 through 178 can be initiated during fingerprint enrollment, for example, The technique can operate in perpetuity until a significant number of fingerprint images of significant quality are obtained. Thus, a user can be directed to obtain additional fingerprint images until a critical mass of images are obtained that can be used to create a meaningful fingerprint template useful for later matching of fingerprint image(s) with the profile, allowing or denying access to a device.

### Enrollment and Matching

At 110 of FIG. 1A, fingerprint feature(s) can be extracted from a fingerprint image. The fingerprint image can have been deemed to be of high enough quality via 108 and/or a valid fingerprint area determined via 106. Examples of features for extraction are minutiae, keypoints, and/or patterns. Extracting identifiable features from a fingerprint image can be used to create a fingerprint template or to match a fingerprint image against a template to determine a match/no-match decision. Minutiae are major features of a fingerprint, using which comparisons of one print with another can be made. Example minutiae include:

Ridge ending—the abrupt end of a ridge;

Ridge bifurcation—a single ridge that divides into two ridges;

Short ridge, or independent ridge—a ridge that commences, travels a short distance and then ends;

Island—a single small ridge inside a short ridge or ridge ending that is not connected to all other ridges;

Ridge enclosure—a single ridge that bifurcates and reunites shortly afterward to continue as a single ridge;

Spur—a bifurcation with a short ridge branching off a longer ridge;

Crossover or bridge—a short ridge that runs between two parallel ridges;

Delta—a Y-shaped ridge meeting; and

Core—a U-turn in the ridge pattern.

A pattern can be a specific pattern of the minutiae organized in a certain fashion. For example, certain minutiae can be organized relative to each other. The features extracted from a fingerprint can be used to generate a fingerprint profile of a user. The use of the features can minimize the size of each profile and also prevent recreation of a fingerprint if a database storing the templates is compromised, for example. The features extracted can also be used for matching purposes to determine if a fingerprint image matches a stored fingerprint template.

At 112, a determination can be made as to if the features are to be used for enrollment or matching. If used for matching, the method can proceed to 114 wherein a determination can be made if the fingerprint features match a stored template. If so, a user can be allowed access 118. If not, the user can be denied access 116. If the features are to be used for enrollment, the method can proceed to 120 wherein the features can be stored as a fingerprint profile.

### Example Results

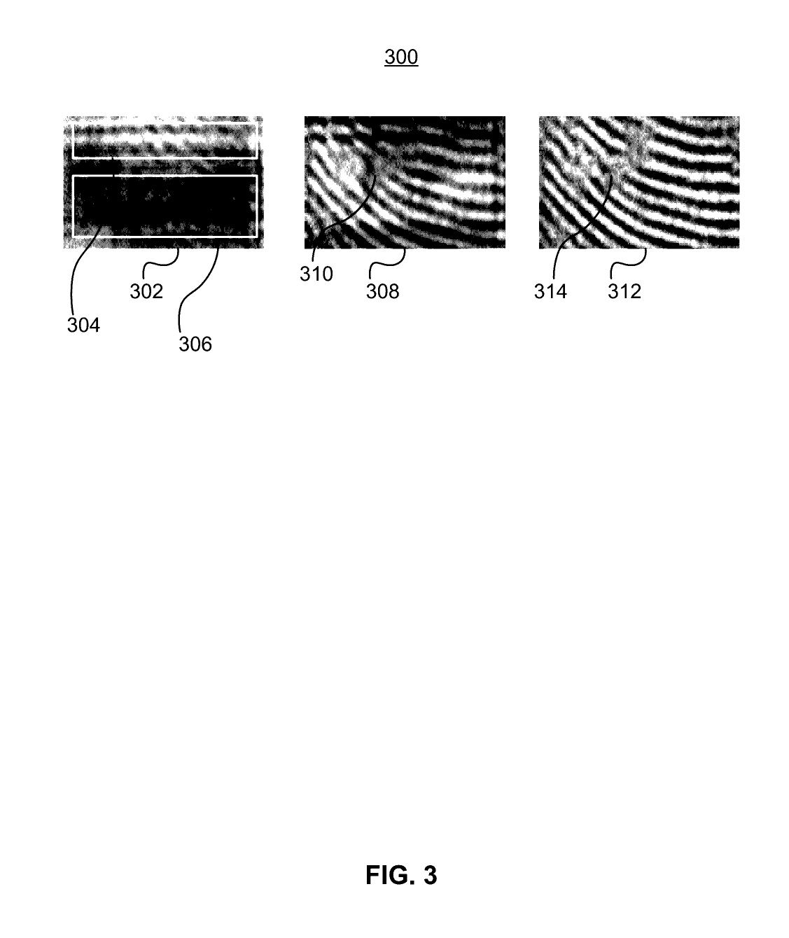

FIG. 3 illustrates several example fingerprint images 300 that can be analyzed using techniques disclosed herein. Image 302 illustrates a poor quality fingerprint image. In image 302, the finger area is less than fifty percent of the total image (the air sub-images represent more than fifty percent of the sub-images). The valid fingerprint area (having finger sub-images) is identified as 304 whereas the air sub-images are illustrated as 306.

Image 308 illustrates a marginal quality fingerprint image having a relatively large valid fingerprint area but with a too many sub-images falling below a threshold quality value. Clouds 310 in this image as well as areas of differing background contrast make fingerprint identification difficult. Image 312 illustrates a good quality fingerprint image having valid finger area greater than fifty percent of the image area and relatively few low quality sub-images (even though some air sub-images 314 exist).

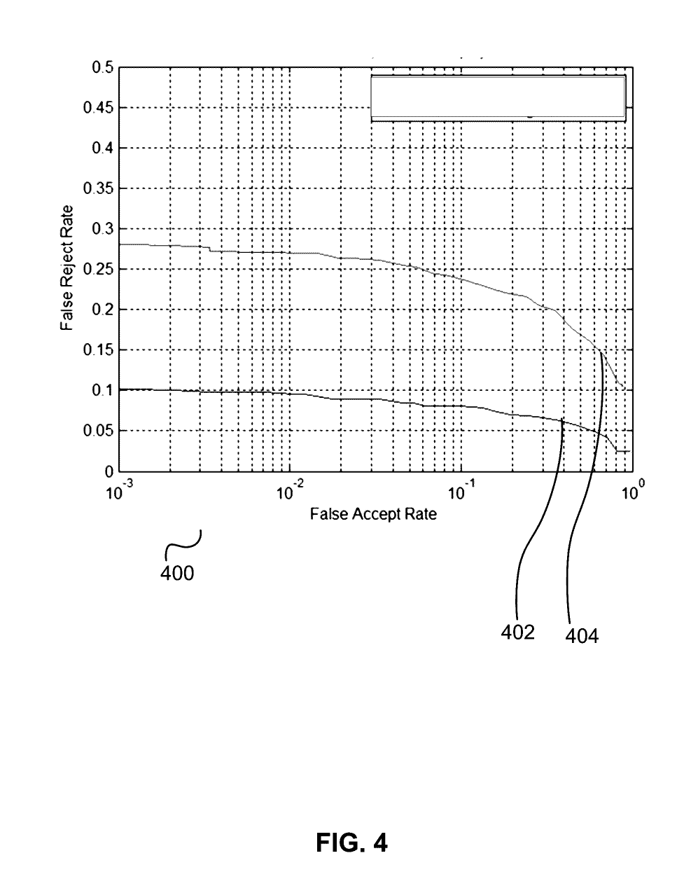

FIG. 4 illustrates a graph 400 illustrating measured improvements of the disclosed method over other methods. Line 402 represents the measured false rejection rate and false acceptance rate using techniques disclosed herein. Line 404 illustrates the false rejection rate and false acceptance rate of other techniques not using those disclosed herein. As should be understood, there can be a correlation between the false acceptance rate and the false rejection rate, as illustrated. Improving the false acceptance rate results in greater numbers of false rejections.

### Implementation

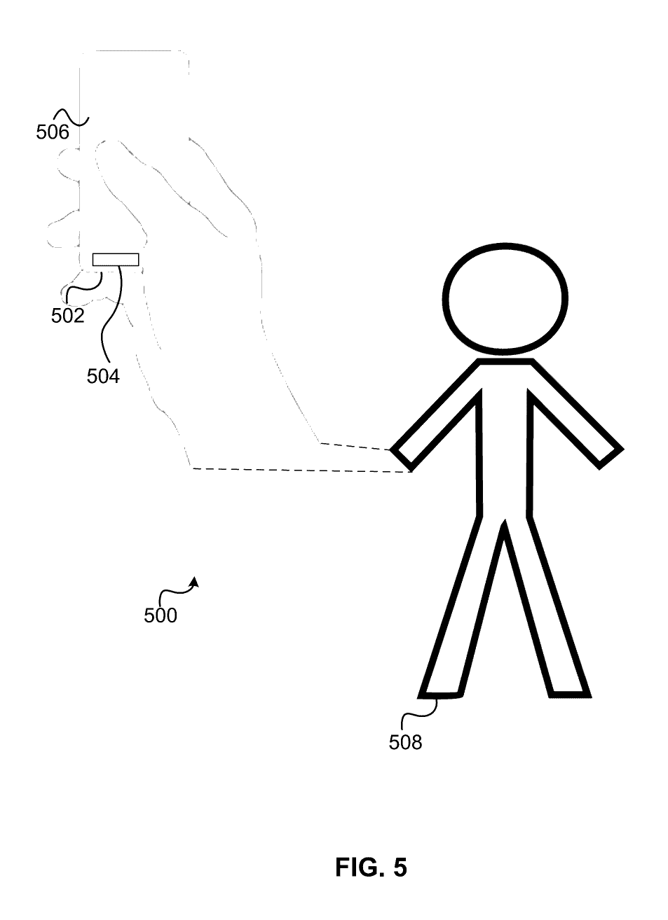

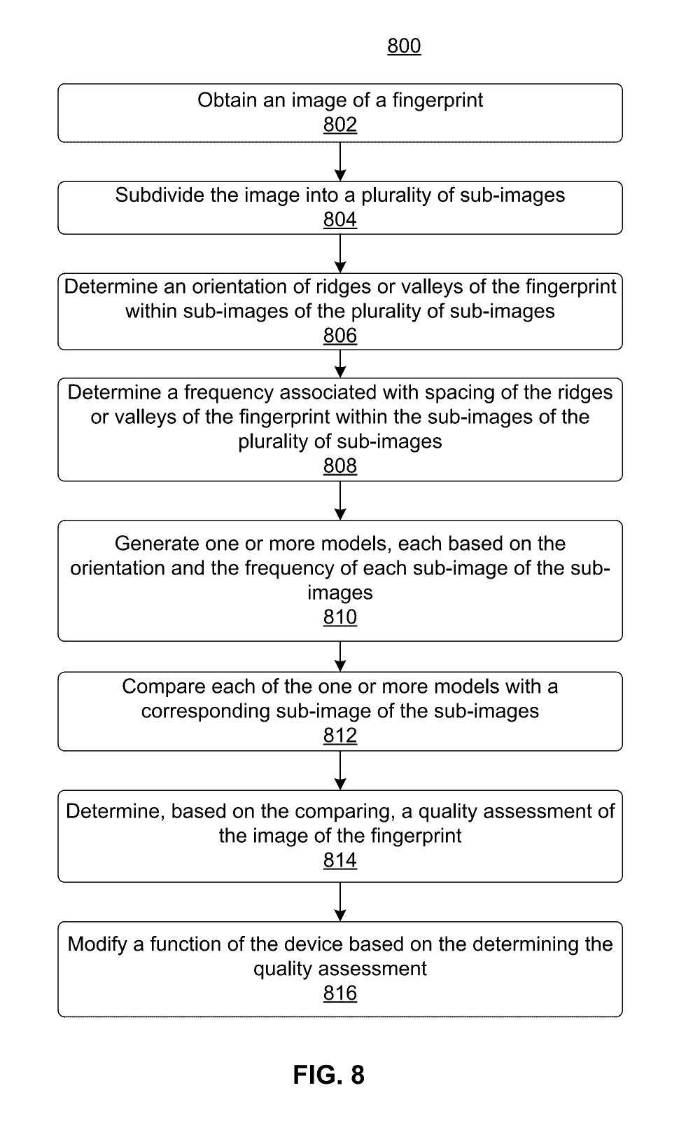

FIG. 5 illustrates a possible embodiment of the system within a mobile electronic device 502 for use by a user 508. The electronics device 502 can have a touch screen 506, fingerprint reader 504, or other fingerprint image capture device. Fingerprint reader 504 can be ultrasonic, visual, or use a different sensing technology. Electronics device 502 can have internal processing hardware such as the computer system hardware illustrated in FIG. 8.

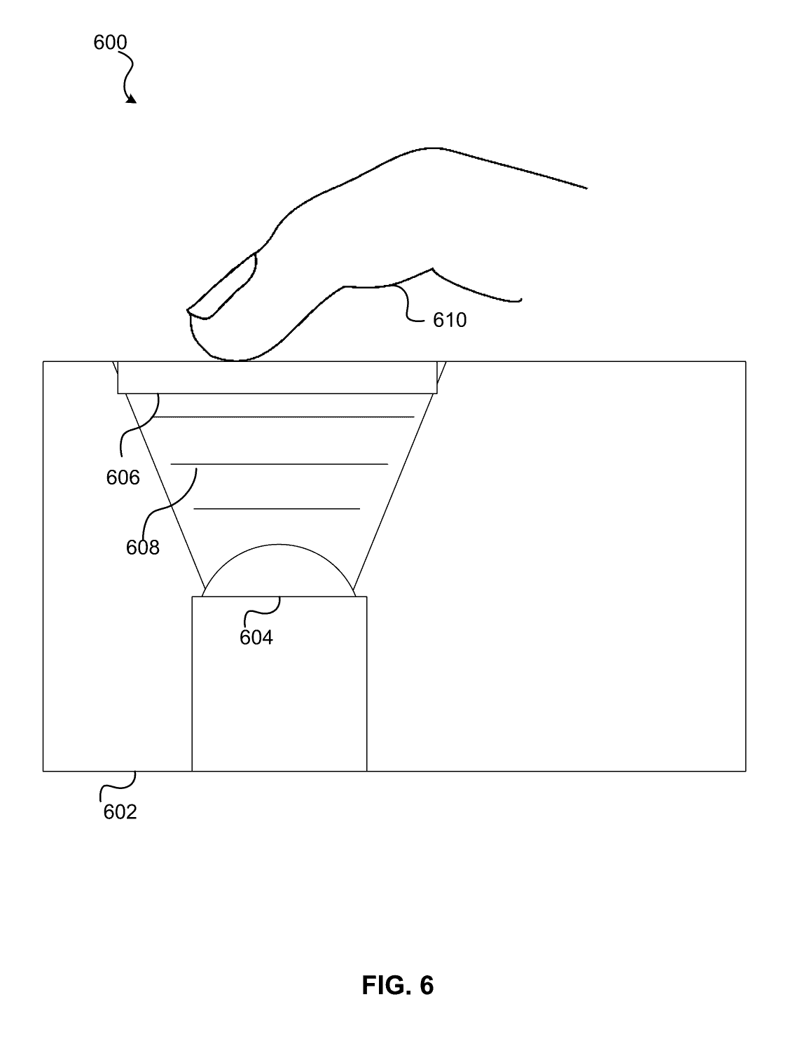

FIG. 6 illustrates an embodiment of a fingerprint sensor system 600 that can be implemented within the electronic device 502 of FIG. 5. Illustrated in FIG. 6 is a housing 602 that can, for example, be included within mobile electronics device 502 containing an ultrasound transducer 604 and a platen 606 through which ultrasonic waves 608 pass through to contact a finger 610 to obtain an image of a fingerprint of finger 610. Ultrasound transducer 604 can, for example, be integrated within fingerprint reader 504. The design of a mobile device, such as a thickness of platen 606 can impact the quality of images obtained using ultrasound transducer 604. In general, a relatively thick platen 606 can result in images with increased noise, lower contrast, and/or blurred edges. However, relatively thin platens can be a structural weak point in device housing 602. Techniques disclosed herein enable fingerprint matching and enrollment techniques to be adapted depending on structural limitations of a device, such as platen thickness. Additionally, techniques disclosed can be tuned or adjusted for platens of different sizes, materials, and/or shapes.

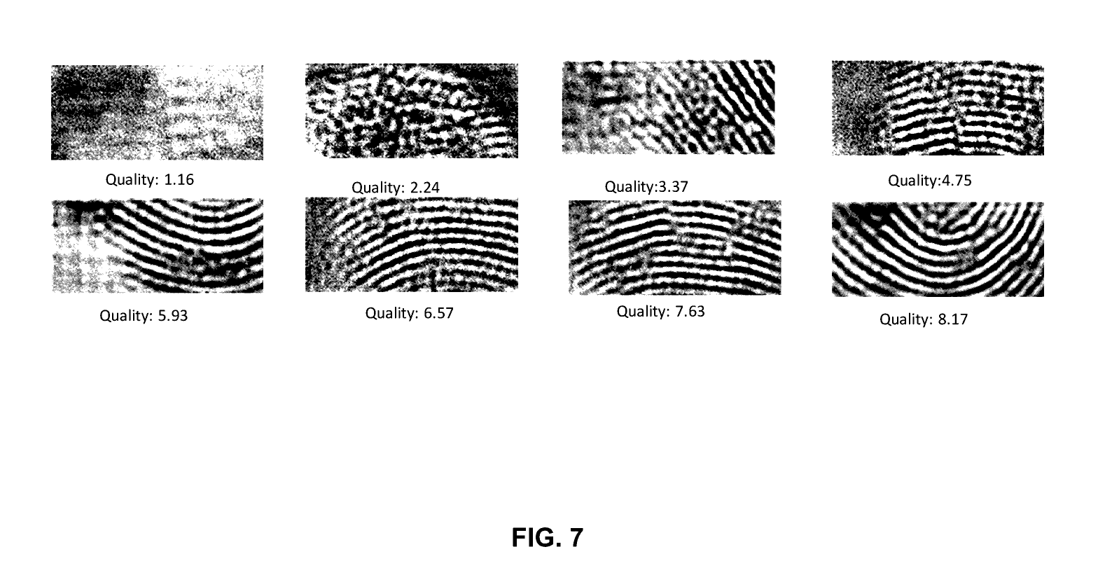

FIG. 7 illustrates various example images with corresponding quality values. The illustrated quality values can be generated at 162, for example. The images of FIG. 7 show increasing quality values ranging from 1.16 to 8.17 (from an overall range of 0.00 to 10.00). As the quality value increases, definition of fingerprint ridges and/or valleys becomes more apparent. Furthermore, fingerprint coverage area increases as the quality value increases,. Using the techniques disclosed herein, a fingerprint template can be generated by 3 images of quality 8.17 or 6 of quality 5.93, for example. By quantitatively assigning scores and thresholds to fingerprint images, quality assessments can be efficiently and quickly implemented with minimal processing overhead.

FIG. 8 illustrates a flowchart 800 for performing techniques according to certain embodiments. Flowchart 802 begins with obtaining an image of a fingerprint 802. The image of the fingerprint can be obtained by a sensor of a device, received from another device, or accessed from a database, for example. At 804, the image can be subdivided into a plurality of sub-images. The plurality of sub-images can be predefined, for example, and each can take one of various shapes, as disclosed herein. At 806, an orientation of ridges or valleys of the fingerprint within sub-images of the plurality of sub-images can be determined. The orientation can, as disclosed herein, indicate a dominant orientation of valleys or ridges within a sub-image. At 808, a frequency associated with spacing of the ridges or valleys of the fingerprint within the sub-images of the plurality of sub-images can be determined. The frequencies can be characteristic frequencies, for example, as disclosed herein. At 810, one or more models, each based on the orientation and the frequency of each sub-image can be generated. The models can include, for example, one or more wavelet models, as disclosed herein. At 812, each of the one or more models can be compared with a corresponding sub-image of the sub-images. At 814, a determination can be made, based on the comparing, of a quality assessment of the image of the fingerprint. At 816, a function of the device can be modified based on the determining the quality assessment.

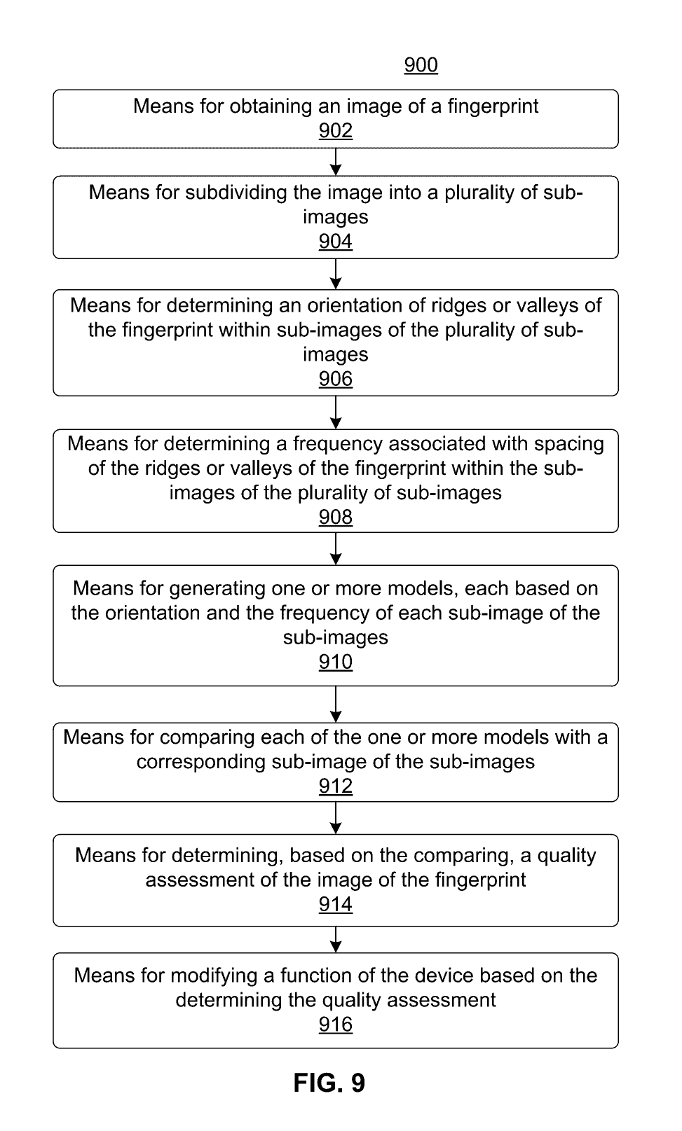

FIG. 9 illustrates a flowchart 900 for performing techniques according to certain embodiments. Flowchart 902 begins with means for obtaining an image of a fingerprint 802. The image of the fingerprint can be obtained by a sensor of a device, received from another device, or accessed from a database, for example. A means for subdividing the image into a plurality of sub-images is provided at 904. The plurality of sub-images can be predefined, for example, and each can take one of various shapes, as disclosed herein. At 906 is a means for determining an orientation of ridges or valleys of the fingerprint within sub-images of the plurality of sub-images. The orientation can, as disclosed herein, indicate a dominant orientation of valleys or ridges within a sub-image. At 908 is a means for determining a frequency associated with spacing of the ridges or valleys of the fingerprint within the sub-images of the plurality of sub-images. The frequencies can be characteristic frequencies, for example, as disclosed herein. At 910, is a means for generating one or more models, each based on the orientation and the frequency of each sub-image. The models can include, for example, one or more wavelet models, as disclosed herein. At 912 a means for comparing each of the one or more models with a corresponding sub-image of the sub-images is provided. At 914 is a means for determining, based on the comparing, a quality assessment of the image of the fingerprint. At 916 is a means for modifying a function of the device based on the determining the quality assessment.

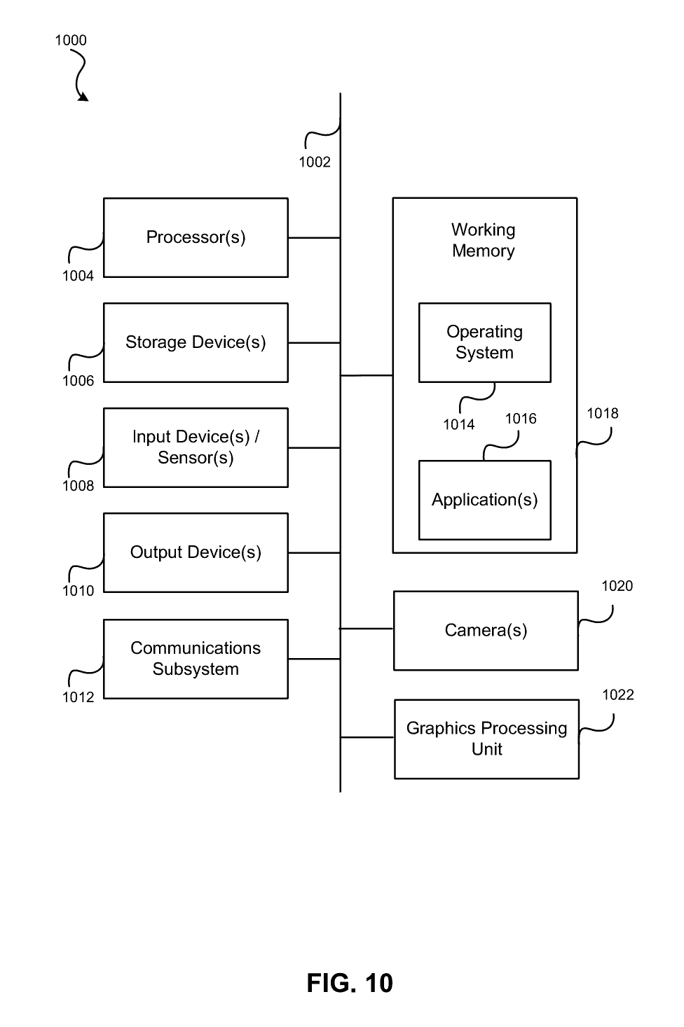

FIG. 10 illustrates an example of a computing system in which one or more embodiments may be implemented.

A computer system as illustrated in FIG. 10 may be incorporated as part of the above described computerized device(s), such as mobile electronic device 502. For example, computer system 1000 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 10 provides a schematic illustration of one implementation of a computer system 1000 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1002 (or may otherwise be in communication, as appropriate). The hardware elements may include one or more processors 1004, including without limitation one or more general-purpose processors and/or one or more special-purpose processors (such as digital signal processing chips, graphics processing units 1022, and/or the like); one or more input device(s)/sensor(s) 1008, which can include without limitation one or more cameras, sensors, a mouse, a keyboard, a microphone configured to detect ultrasound or other sounds, and/or the like; and one or more output devices 1010, which can include without limitation a display unit such as the device used in implementations of the invention, a printer and/or the like. Additional cameras 1020 may be employed for detection of user's extremities and gestures. In some implementations, input device(s)/sensor(s) 1008 may include one or more sensors such as infrared, depth, and/or ultrasound sensors. The graphics processing unit 1022 may be used to carry out the method for real-time wiping and replacement of objects described above.

In some implementations of the implementations of the invention, various input device(s)/sensor(s) 1008 and output devices 1010 may be embedded into interfaces such as display devices, tables, floors, walls, and window screens. Furthermore, input device(s)/sensor(s) 1008 and output devices 1010 coupled to the processors may form multi-dimensional tracking systems.

The computer system 1000 may further include (and/or be in communication with) one or more non-transitory storage devices 1006, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1000 might also include a communications subsystem 1012, which can include without limitation a modem, a network card (wireless or wired), an infrared communication device, a wireless communication device and/or chipset (such as a Bluetooth device, an 1002.11 device, a WiFi device, a WiMax device, cellular communication facilities, etc.), and/or the like. The communications subsystem 1012 may permit data to be exchanged with a network, other computer systems, and/or any other devices described herein. In many implementations, the computer system 1000 will further comprise a non-transitory working memory 1018, which can include a RAM or ROM device, as described above.

The computer system 1000 also can comprise software elements, shown as being currently located within the working memory 1018, including an operating system 1014, device drivers, executable libraries, and/or other code, such as one or more application programs 1016, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1006 described above. In some cases, the storage medium might be incorporated within a computer system, such as computer system 1000. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 1000 and/or might take the form of source and/or installable code, which, upon compilation and/or installation on the computer system 1000 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 1000 may be omitted or may be implemented separate from the illustrated system. For example, the processor 1004 and/or other elements may be implemented separate from the input device 1008. In one implementation, the processor may be configured to receive images from one or more cameras that are separately implemented. In some implementations, elements in addition to those illustrated in FIG. 10 may be included in the computer system 1000.

Some implementations may employ a computer system (such as the computer system 1000) to perform methods in accordance with the disclosure. For example, some or all of the procedures of the described methods may be performed by the computer system 1000 in response to processor 1004 executing one or more sequences of one or more instructions (which might be incorporated into the operating system 1014 and/or other code, such as an application program 1016) contained in the working memory 1018. Such instructions may be read into the working memory 1018 from another computer-readable medium, such as one or more of the storage device(s) 1006. Merely by way of example, execution of the sequences of instructions contained in the working memory 1018 might cause the processor(s) 1004 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 1000, various computer-readable media might be involved in providing instructions/code to processor(s) 1004 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 1006. Volatile media include, without limitation, dynamic memory, such as the working memory 1018. Transmission media include, without limitation, coaxial cables, copper wire and fiber optics, including the wires that comprise the bus 1002, as well as the various components of the communications subsystem 1012 (and/or the media by which the communications subsystem 1012 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1004 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000. These signals, which might be in the form of electromagnetic signals, acoustic signals, optical signals and/or the like, are all examples of carrier waves on which instructions can be encoded, in accordance with various implementations of the invention.

The communications subsystem 1012 (and/or components thereof) generally will receive the signals, and the bus 1002 then might carry the signals (and/or the data, instructions, etc. carried by the signals) to the working memory 1018, from which the processor(s) 1004 retrieves and executes the instructions. The instructions received by the working memory 1018 may optionally be stored on a non-transitory storage device 1006 either before or after execution by the processor(s) 1004.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. A device, comprising:
a processor configured to:
obtain an image of a fingerprint;
subdivide the image into a plurality of sub-images;
determine an orientation of ridges or valleys of the fingerprint within sub-images of the plurality of sub-images;
determine a frequency associated with spacing of the ridges or valleys of the fingerprint within the sub-images of the plurality of sub-images;
generate one or more models, each based on the orientation and the frequency of each sub-image of the sub-images;
compare each of the one or more models with a corresponding sub-image of the sub-images;
determine, based on the comparing, a quality assessment of the image of the fingerprint; and
modify a function of the device based on the determining the quality assessment.

2. The device of claim 1, wherein the orientation is a dominant orientation of ridges or valleys of the fingerprint within the sub-images of the plurality of sub-images, wherein the dominant orientation includes a single orientation value representing orientations of ridges or valleys within each sub-image of the sub-images.

3. The device of claim 1, wherein the frequency is a characteristic frequency of ridges or valleys of the fingerprint within the sub-images of the plurality of sub-images, wherein the characteristics frequency includes a single frequency value representing frequencies of ridges or valleys within each sub-image of the sub-images.

4. The device of claim 3, where the processor is further configured to:
transform at least one sub-image of the sub-images to obtain a frequency domain sub-image;
determine a magnitude for each of a plurality of peaks of the frequency domain sub-image;
determine a frequency associated with each of the plurality of peaks determined from the frequency domain sub-image;
average the frequencies associated with each of the plurality of peaks, the averaging being weighted by the magnitude of each of the plurality of peaks; and
determining the characteristic frequency based on the averaging.

5. The device of claim 1, wherein the processor is further configured to:
perform a domain transformation on the sub-images from a spatial domain to a frequency domain, wherein the frequency and the orientation are determined based on frequency domain transformed sub-images.

6. The device of claim 5, wherein the processor is further configured to:
determine the orientation and frequency based on a frequency domain representation of a sub-image of the sub-images,
wherein the comparing each of the one or more models with a corresponding sub-image of the sub-images is based on a spatial domain representation of the sub-image of the sub-images.

7. The device of claim 1, wherein the processor is further configured to:
determine whether a dominant orientation of ridges or valleys or a characteristic frequency associated with spacing of ridges or valleys within a sub-image of the plurality of sub-images is present within a sub-image of the plurality of sub-images; and
upon determining that either the dominant orientation of ridges or valleys or the characteristic frequency associated with spacing of ridges or valleys are not present within a the sub-image, flagging the sub-images as an air sub-image.

8. The device of claim 7, wherein the sub-image is further flagged as an air sub-image based on a determination of whether the sub-images meet a signal to noise ratio threshold.

9. The device of claim 7, wherein the determining the quality assessment includes determining whether a ratio meets a quality threshold, the ratio being of sub-images that are not flagged as air sub-images to sub-images that are flagged as air sub-images.

10. The device of claim 1, wherein the processor is further configured to:
smooth orientations of ridges of valleys of sub-images of the plurality of sub-images with adjacent sub-images of the plurality of sub-images, the smoothing including adjusting a value of an orientation of ridges or valleys within a sub-image with an adjacent sub-image orientation value.

11. The device of claim 1, wherein the determining the quality assessment includes generating a quality value for the image; and
the processor is further configured to:
determine whether a first summation of a plurality of quality values meets a first quality threshold, each quality value of the plurality of quality values generated for each of a plurality of images of a fingerprint; and
generate a fingerprint profile based the determining whether the first summation of the plurality of quality values meets the first quality threshold.

12. The device of claim 11, wherein the processor is further configured to:
obtain a total number of the plurality of images in a given time period; and
determine whether a second summation of a number of quality values meets a second quality threshold, each quality value of the number of quality values generated for an image of the plurality of images,
wherein the generating the fingerprint profile is based on the determining whether second first summation of the plurality of quality values meets the second quality threshold.

13. The device of claim 11, wherein the processor is further configured to:
based on determining that the first summation does not meet the first quality threshold, adjust the value of the first quality threshold for future obtained images of fingerprints.

14. The device of claim 11, wherein the processor is further configured to:
obtain the plurality of images of the fingerprint of the user;
sequentially generate a quality value for each of the plurality of images;
determine whether a generated quality value is greater than a previously generated quality value; and
based on the determining whether the generated quality value is greater than the previously generated quality value, include the quality value in the first summation of the plurality of quality values.

15. The device of claim 1, wherein the generating the one or more models includes generating a wavelet model.

16. The device of claim 15, wherein the comparing each of the one or more models with a corresponding sub-image of the sub-images includes performing two dimensional filtering on each of the one or more models with a corresponding sub-image of the sub-images.

17. The device of claim 1, wherein the determining the quality assessment includes generating a quality score for the image of the fingerprint; and
the modifying the function of the device is further based on determining whether the quality score meets a threshold.

18. The device of claim 1, wherein the modifying the function of the device includes at least one of:
generating a fingerprint profile; or
determining whether at least a portion of the image matches a fingerprint profile.

19. A method, comprising:
obtaining, by a device, an image of a fingerprint;
subdivide the image into a plurality of sub-images;
determine an orientation of ridges or valleys of the fingerprint within sub-images of the plurality of sub-images;
determine a frequency associated with spacing of ridges or valleys of the fingerprint within the sub-images of the plurality of sub-images;
generate one or more models, each based on the orientation and the frequency of each sub-image of the sub-images;
compare each of the one or more models with a corresponding sub-image of the sub-images;
determine, based on the comparing, a quality assessment of the image of the fingerprint; and
modify a function of the device based on the determining the quality assessment.

20. A device, comprising:
a means for obtaining an image of a fingerprint;
a means for subdividing the image into a plurality of sub-images;
a means for determining an orientation of ridges or valleys of the fingerprint within sub-images of the plurality of sub-images;
a means for determining a frequency associated with spacing of ridges or valleys of the fingerprint within the sub-images of the plurality of sub-images;
a means for generating one or more models, each based on the orientation and the frequency of each sub-image of the sub-images;
a means for comparing each of the one or more models with a corresponding sub-image of the sub-images;
a means for determining, based on the comparing, a quality assessment of the image of the fingerprint; and
a means for modifying a function of the device based on the determining the quality assessment.
